(19) United States
(12) Patent Application Publication
(10) Pub. No.: US 2005/0024637 A1
(43) Pub. Date: Feb. 3, 2005

(54) Detector and method for detecting weak fluorescent radiation with a microscope system

(75) Inventor: Frank Olschewski, Heidelberg (DE)

Correspondence Address: HOUSTON ELISEEVA, 4 MILITIA DRIVE, SUITE 4, LEXINGTON, MA, 02421, US

(73) Assignee: Leical Microsystems Heidelberg GmbH, Mannheim (DE)

(21) Appl. No.: 10/894,554

(22) Filed: Jul. 20, 2004

(30) Foreign Application Priority Data
Aug. 2, 2003 (DE) DE 103 35 471.9

(51) Int. Cl. G01N 21/64

(52) U.S. Cl. 356/318; 250/458.1

(57) ABSTRACT

A detector for detecting weak fluorescent radiation with a microscope system (100) is disclosed. The microscope system (100) is configured in such a way that it senses individual photons of the detected light beam (17) each as one event (50), and furnishes therefrom an output signal in the form of a characteristic function (52). A filter circuit (61) forms, from the characteristic function (52), a new characteristic function (55) that is conveyed to a discriminator (60).

### RELATED APPLICATIONS

This application claims priority of the German patent application 103 35 471.9 which is incorporated by reference herein.

### FIELD OF THE INVENTION

The, invention concerns a detector for detecting weak fluorescent radiation with a microscope system.

The invention furthermore concerns a method for detecting weak fluorescent radiation with a microscope system.

### BACKGROUND OF THE INVENTION

German Unexamined Application DE 101 109 25 A1 discloses a method for photon counting in a laser scanning system. Photon counting is accomplished by the fact that the individual pulses are compared with several thresholds. Based on the location of the threshold, the various peaks have allocated to them different photon numbers from which they were produced. For example, if a peak that comprises two photons does not reach the threshold provided for two photons, then only one photon is counted for that peak.

### SUMMARY OF THE INVENTION

It is the object of the invention to create a detector with which even weak fluorescent signals can reliably be sensed, and with which accurate counting of the photons is accomplished.

The aforesaid object is achieved by way of a microscope system comprising: a microscope system which defines a detected light beam; a detection unit is provided for sensing individual photons of the detected light beam, wherein each photon is detected as one event and furnishes therefrom an output signal in the form of a characteristic function; a filter circuit that forms a new characteristic function from the characteristic function; and the filter circuit followed by a discriminator that distinguishes individual events on the basis of the new characteristic function and a threshold.

A further object of the invention is to create a method with which even weak fluorescent signals, such as those that occur in living-cell applications, can reliably be sensed. The aforesaid object is achieved by way of a method for detecting weak fluorescent radiation with a microscope system that encompasses at least one detector, characterized by the following steps:
conveying to a filter circuit a characteristic function, outputted by the detector, of one event;
generating a new characteristic function by an application of the characteristic function to an approximately mirrored characteristic function for correlation in the filter circuit;
conveying the new characteristic function to a discriminator; and
counting the events in a counter downstream from the discriminator.

The invention has the advantage that with the detector, it is possible to detect weak fluorescent radiation with a microscope system. The microscope system defines a detected light beam in which is provided a detection unit that detects each of the individual photons of the detected light beam as one event, and furnishes therefrom an output signal in the form of a characteristic function. Also provided is a filter circuit that forms, from the characteristic function, a new characteristic function. Downstream from the filter circuit is a discriminator that distinguishes individual events on the basis of the new characteristic function and a threshold value.

The filter circuit can be configured in analog or digital fashion. Also provided is a corresponding software program with evaluation and determination of the individual events.

### BRIEF DESCRIPTION OF THE DRAWINGS

The subject matter of the invention is schematically depicted in the drawings and will be described below with reference to the Figures, in which:

FIG. 1 schematically depicts a scanning microscope, the detectors being preceded by an SP module;

FIG. 2a schematically depicts several photons that are recorded as events over a specific time dT;

FIG. 2b shows a characteristic function with which, for example, one photon is recorded at the detector;

FIG. 3a shows a signal at the photomultiplier, a threshold for discrimination of the characteristic function being provided;

FIG. 3b depicts two characteristic functions as they are recorded as a result of two photons at the detector;

FIG. 3c depicts the signal processing operation in which a separation into two discrete events is possible; and

FIG. 4 graphically depicts the functioning of the signal processing operation.

### DETAILED DESCRIPTION OF THE INVENTION

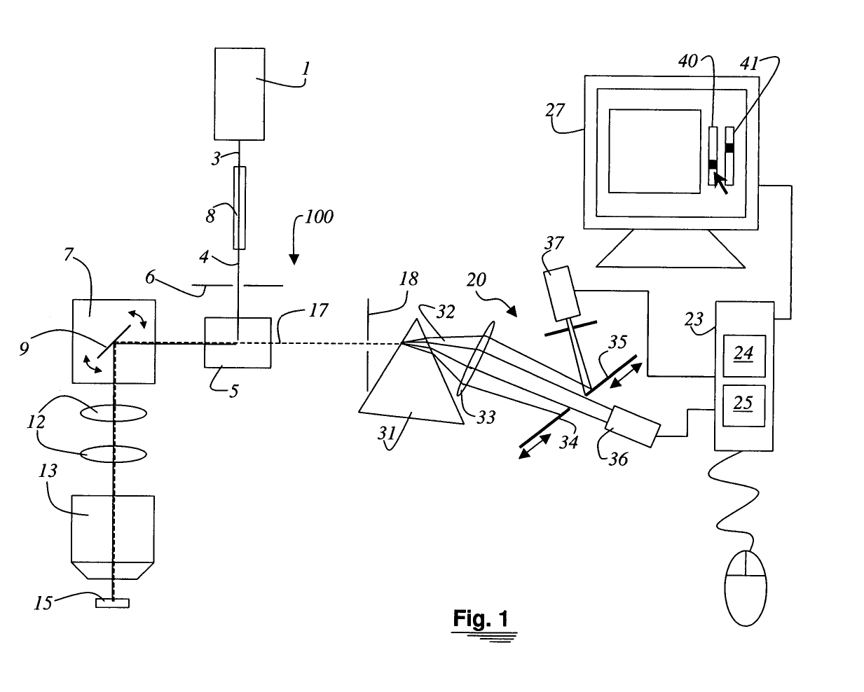

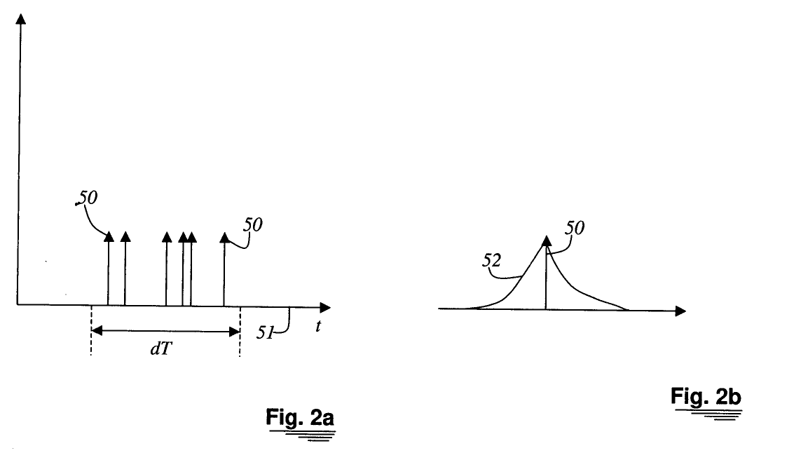

FIG. 1 schematically shows the exemplary embodiment of a confocal scanning microscope. This is not to be construed as a limitation of the invention, however, since this is only one application for a sensitive detector such as the one sketched in FIG. 2. Illuminating light beam 3 coming from at least one illumination system 1 is conveyed by a beam splitter or a suitable deflection means 5 to a scanning module 7. Before illuminating light beam 3 strikes deflection means 5, it passes through an illumination pinhole 6. Scanning module 7 encompasses a gimbal-mounted scanning mirror 9 that guides illuminating light beam 3 through a scanning optical system 12 and a microscope optical system 13, over or through a specimen 15. Illumination system 1 can be configured in such a way that it generates white light from the light of a laser 10. A microstructured element 8 or a tapered glass fiber is provided for this purpose. With biological specimens 15 (preparations) or transparent specimens, illuminating light beam 3 can also be guided through specimen 15. For these purposes, non-luminous preparations are prepared, if applicable, with a suitable dye and often also with several dyes (not depicted, since this is established existing art). The dyes present in specimen 15 are excited by illuminating light beam 3 and emit light in a characteristic region of the spectrum peculiar to them. This light proceeding from specimen 15 defines a detected light beam 17. Detected light beam 17 travels to a detector module 22. Detected light beam 17 travels through microscope optical system 13 and scanning optical system 12 and via scanning module 7 to deflection means 5, passes through the latter, and arrives at detector module 22. Through a detection pinhole 18 it strikes at least one detector 36, 37, each embodied as a photomultiplier. The detector specified in FIG. 2 is to be classified as having this characteristic, since it behaves like a better photomultiplier. It is sufficiently clear to one skilled in the art, however, that other detector forms (CMOS, CCD, diodes) can also be used. Detected light beam 17 proceeding from or defined by specimen 15 is depicted in FIG. 1 as a dashed line. Electrical detected signals proportional to the power level of the light proceeding from specimen 15 are generated in detectors 36, 37. Because, as already mentioned above, light of more than one wavelength is emitted from specimen 15, it is useful to provide an SP module 20 in front of the at least one detector 36, 37. The data generated by the at least one detector 36, 37 are conveyed to a computer system 23. At least one peripheral device 27 is associated with computer system 23. Peripheral device 27 can be, for example, a display on which the user receives instructions for adjusting scanning microscope 100, or can view the current setup and also the image data in graphical form. Additionally associated with computer system 23 is an input means 28 that comprises, for example, a keyboard, an adjusting apparatus for the components of the microscope system, and/or a mouse 30. Also associated with computer system 23 is a memory 24 in which the data sets are stored. Additionally implemented in computer system 23 is a software program 25 with which appropriate calculations can be performed. In addition, adjusting elements 40, 41 for image acquisition are furthermore displayed on display 27. In the embodiment shown here, adjusting elements 40, 41 are depicted as sliders. Adjusting elements 40, 41 can likewise be embodied as check boxes with which a yes/no activation for certain parameters is possible. Any other configuration lies within the specialized ability of one skilled in the art. Detected light beam 17 is spatially spectrally divided with a prism 31. A further possibility for spectral division is the use of a reflection or transmission grating. Spectrally divided light fan 32 is focused with focusing optical system 33 and then strikes a mirror stop arrangement 34, 35. Mirror stop arrangement 34, 35, the means for spectral spatial division, focusing optical system 33, and detectors 36 and 37 are together referred to as SP module 20 (or the multi-band detector).

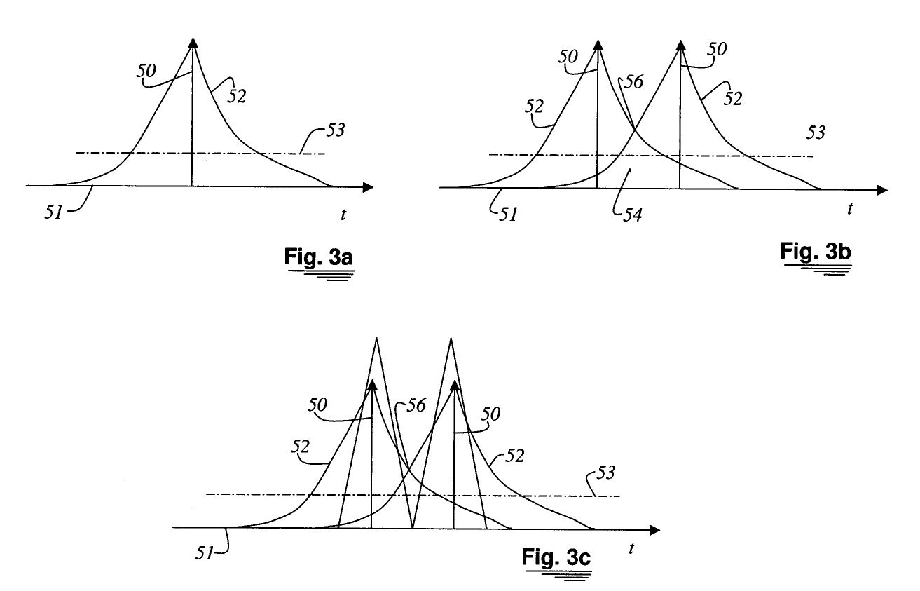

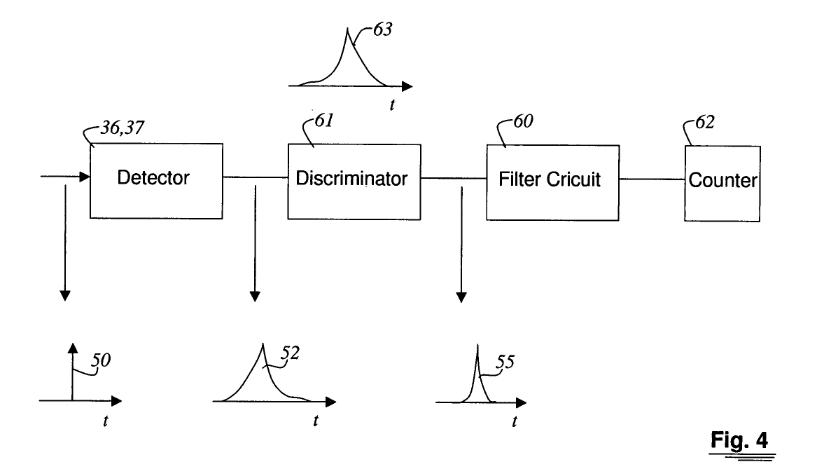

If the focus of a confocal microscope, as depicted in FIG. 1, is directed for a specific time dT onto a point in specimen 15, individual photons are then emitted from that point in the specimen and are detected by detector 36, 37. In FIG. 2a, the individual photons proceeding from specimen 15 are depicted as arrows, the individual arrows each standing for one (singular) event 50 that is depicted over time t. (This nomenclature is common in signal processing and in physics for idealized modeling, and is called a Dirac pulse.) Time t is plotted on abscissa 51. The individual photons of the fluorescent light or of the light proceeding from specimen 15 are singular events 50 that are represented by detectors 36, 37 in a characteristic function 52. The photon flux over time can be represented for each photon at detector 36, 37 (which can be, for example, a photomultiplier) as characteristic function 52. In one exemplary embodiment, characteristic function 52 is a Dirac function (see FIG. 2b). Two different processes occur at detector 36, 37. The photon or event 50 arrives at detector 36, 37 and is smeared out over time (convoluted) by characteristic function 52, this characteristic function 52 being relatively constant (see FIG. 2b) and being dependent (as applicable) on the incidence direction and the differing energy of a photon, whose signal strengths are present at the end of detector 36, 37. The conventional manner of operation of a photon counter involves a threshold value 53 (discriminator), a signal transition of the PMT output above that threshold being counted as an event (see FIG. 3a). It is evident from FIG. 3b that this manner of operation of the photon counter can function only in a low-light situation (small number of photons). The situation depicted in FIG. 3b is one in which several photons arrive in quick succession at detector 36, 37. The individual characteristic functions 52 associated with the events or singularities possess an overlap region 54. The characteristic functions moreover share an intersection point 56. In the situation depicted in FIG. 3b, intersection point 56 lies above threshold value 53, so that two photons arriving one after another are not recognized as two events 50. A separation of the individual events 50 is depicted in FIG. 3c. Since characteristic function 52 is known, an upstream signal processor can be provided that reshapes or sharpens the pulse generated by the singularity. Two different embodiments of a method are possible. A first embodiment is a deconvolution of the time signal. A second embodiment is a correlation determination and a transition to a correlation detector (matched filter). Deconvolution is included here only for completeness, since although it is possible in principle, it is so complex and expensive and difficult that no one would actually want to use it. Correlation detection, however, is a simple and easily applied concept. Characteristic function 52 is known (it is relatively constant), and the cross-correlation with the expected signal can therefore be calculated from the input signal. In addition, given slight variations in the characteristic function, a sufficiently accurate approximation thereof can be determined. The filtering itself then happens substantially by way of an analog convolution integral, if an implementation in the form of an electronic filter is considered. A digital convolution sum is also possible, if the signal at the detector is converted very quickly and everything is then performed as an algorithm in the FPGA or something similar. Characteristic function 52 is then replaced in each case by a new characteristic function 55 that was ascertained using one of the aforementioned methods. In practice, this means that a filter circuit 61 for signal processing is placed between detector 36, 37 and discriminator 60 which has a pulse response mirroring characteristic function 52 (see FIG. 4). The effect of this filter circuit 61 is that an input signal (characteristic function 52) is made up of a superposition with a mirrored characteristic function 63, or approaches it with sufficient accuracy. The result obtained is a new characteristic function 55 that better separates the individual components. FIG. 3c elucidates the operation of filter circuit 61. Filter circuit 61 suppresses interference due to pink noise (i.e. events having a shape other than that expected as a result of the characteristic function); in other words, the signal-to-noise ratio and detection are better in practical use. Filter circuit 61 forms new characteristic function 55, which rises more sharply because it substantially concentrates the signal onto the point or singularity at which the similarity to the original characteristic function 52 is greatest. The resulting individual new characteristic functions 55 are better separated. New characteristic function 55 is such that an overlap 56 of new characteristic function 55 form with respect to the maximum and thus, with a suitably defined threshold value (relative to the maximum), lies below threshold value 53. Cascades of events 50 in rapid succession can be better separated. As a result of new characteristic function 55, counter 62 downstream from discriminator 60 senses events 50 as individual events separate from one another. It is directly evident that this method permits operation of a photon counter with higher photon counts. An integrative approach also profits from it, since interference is filtered out.

The invention has been described with reference to a particular exemplary embodiment. It is self-evident, however, that changes and modifications can be made without thereby leaving the range of protection of the claims below.

### Parts list

1 illumination system
3 illuminating light beam
5 deflection means
6 illumination pinhole
7 scanning module
8 microstructured element
9 scanning mirror
10 laser
12 scanning optical system
13 microscope optical system
15 specimen
17 detected light beam
18 detection pinhole
20 sp module
22 detector module
23 computer system
24 memory
25 software
27 peripheral device
30 mouse
31 prism
32 divided light fan
33 focusing optical system
34 mirror stop arrangement
35 mirror stop arrangement
36 detector
37 detector
50 event
51 abscissa
52 characteristic function
53 threshold
54 overlap region
55 new characteristic function
56 intersection point
60 discriminator
61 filter circuit
62 counter
63 mirrored characteristic function
100 microscope system

1. A detector for detecting weak fluorescent radiation comprising: a microscope system which defines a detected light beam; a detection unit is provided for sensing individual photons of the detected light beam, wherein each photon is detected as one event and furnishes therefrom an output signal in the form of a characteristic function; a filter circuit that forms a new characteristic function from the characteristic function; and
the filter circuit followed by a discriminator that distinguishes individual events on the basis of the new characteristic function and a threshold.

2. The detector as defined in claim 1, wherein the filter circuit is embodied in the form of an analog electronic system.

3. The detector as defined in claim 1, wherein the filter circuit is constituted by a digital electronic system.

4. The detector as defined in claim 3, wherein the filter circuit coacts with a software program.

5. The detector as defined in claim 1, wherein the discriminator is followed by a counter that counts the events distinguished by the discriminator.

6. A method for detecting weak fluorescent radiation with a microscope system that encompasses at least one detector, characterized by the following steps: conveying to a filter circuit a characteristic function, outputted by the detector, of one event;
generating a new characteristic function by an application of the characteristic function to an approximately mirrored characteristic function for correlation in the filter circuit;
conveying the new characteristic function to a discriminator; and
counting the events in a counter downstream from the discriminator.

7. The method as defined in claim 6, wherein the characteristic function outputted by the detector is shaped in the filter circuit; and the filter circuit is analog.

8. The method as defined in claim 6, wherein the characteristic function outputted by the detector is shaped in the filter circuit; and the filter circuit is digital.

9. The method as defined in claim 8, wherein the filter circuit coacts with a software program.
